(19) United States
(12) Patent Application Publication
(10) Pub. No.: US 2006/0055143 A1
(43) Pub. Date: Mar. 16, 2006

(54) Rear wheel mount and optional suspension for wheelchair

(75) Inventors: Philip H. Schreiber, Denver, CO (US); Michael Knopf, Dielheim (DE); Errol Marklein, Tairnbach (DE); Steven L. Lindquist, Broomfield, CO (US); Joshua J. Heit, Westminster, CO (US); Allen B. Killebrew, Erie, CO (US); Todd Bernatsky, Lafayette, CO (US)

Correspondence Address: MACMILLAN SOBANSKI & TODD, LLC;ONE MARITIME PLAZA FOURTH FLOOR, 720 WATER STREET, TOLEDO, OH, 43604-1619, US

(73) Assignee: Sunrise Medical HHG Inc.

(21) Appl. No.: 11/223,426

(22) Filed: Sep. 9, 2005

Related U.S. Application Data
(60) Provisional application No. 60/608,604, filed on Sep. 10, 2004.

(51) Int. Cl. B62M 1/14

(52) U.S. Cl. 280/250.1

(57) ABSTRACT

A wheel mount may generally be comprised of an axle plate and a camber tube clamp that may be height adjustable with respect to the axle plate. The camber tube clamp can be selectively mountable upright or inverted so as to increase an overall range of height adjustability. The camber tube clamp can be mountable in front of or behind the axle plate so as to increase an overall range of center-of-gravity adjustability. The camber tube clamp and the axle plate may have an interlocking feature that may allow the camber tube clamp to slide vertically along the axle plate to facilitate height adjustment. A seat collar can be positioned at various locations along a wheelchair frame for center-of-gravity adjustment. The axle plate can be detached from and attached to the seat tube collar to allow the axle plate and camber tube clamp to be reverse mounted in order to increase the range of center of gravity adjustment. A wheelchair suspension system according to the invention may be comprised of a swing arm and at least one elastomer. The swing arm may be adapted to support a rear wheelchair wheel and pivot about an axis substantially fixed to a wheelchair frame. The swing arm can be suspended between two of the elastomers, or be operatively connected to one elastomer so that displacement of the swing arm in either direction about the pivot causes the elastomer to compress.

### CROSS REFERENCE TO RELATED APPLICATIONS

This application claims the benefit of U.S. Provisional Patent Application No. 60/608,604, filed on Sep. 10, 2004.

### BACKGROUND OF INVENTION

This invention relates in general to land vehicles and more particularly, to personal mobility vehicles. Most particularly, the invention relates to wheel mounts for wheelchairs.

This invention relates in general to improvements in wheel mount assemblies of the type used with wheelchairs and other devices. More particularly, this invention relates to an improved wheel mount assembly that provides wheel height adjustability, center-of-gravity adjustability, and camber toe-in/toe-out adjustability.

Wheel mount assemblies in general are well known in the art for use with many different types of wheeled devices. Such wheel mount assemblies are commonly employed for mounting the rear wheels on a typical wheelchair. Each wheel mount assembly typically incorporates a number of adjustments that allow the wheelchair occupant to customize the wheelchair to his or her anthropometry and driving conditions. Typically manual wheelchairs provide a height adjustment in the rear wheels and/or the front casters. Frequently, the rear wheels of the wheelchair are cambered, or angled with respect to a vertical plane. A wheelchair with a large camber angle has more responsive turning, which is typically beneficial in sports applications. A wheelchair with a little to no camber angle has a smaller overall width and thus greater maneuverability in tight confines.

When an adjustment is made to the rear wheel height or front caster height on a wheelchair with cambered wheels, the rear wheels will toe in or toe out. That is to say, the rear wheels become misaligned with respect to the ground plane. This misalignment is undesirable because it increases rolling friction. If the rear wheels are raised or the front casters are lowered, the rear wheels will toe out. Conversely, if the rear wheels are lowered or the front casters are raised, the rear wheels will toe in. This occurs because the axis of the camber is no longer aligned horizontally. To correct this, the mounting hardware that attaches the rear wheels to the wheelchair frame must allow the axles of the rear wheels to rotate in order to re-align the camber angle with respect to horizontal.

Some wheelchairs, typically high-performance wheelchairs, provide the ability to adjust the fore/aft position of the rear wheels with respect to the wheelchair frame. Such adjustment is known as a center-of-gravity adjustment. Moving the rear wheels rearward produces a more stable chair that is less likely to tip backwards. Moving the rear wheels forward makes the chair easier to balance on the rear wheels. This helps with maneuverability over obstacles, such as curbs, where the wheelchair occupant must lift the front casters off the ground in order to traverse the obstacle.

While many wheelchairs provide wheel height, camber toe-in/toe-out and center-of-gravity adjustability, there is strong demand for a design that offers user-friendly adjustment and is lightweight.

Rear wheel suspension assemblies in general are well known in the art for use with many different types of wheeled devices, including wheelchairs. Rear wheel suspension is employed in wheelchairs to absorb shock when traversing rough terrain or going off curbs, thereby producing a less fatiguing, lower impact ride for the user. Rear suspension provides therapeutic benefits by reducing lower back stress, rider fatigue, and the likelihood of seating pressure sores. High-end wheelchair suspension systems in the industry include the use of fluid damping, spring or air shock components that were developed for the bicycle industry. These components typically are heavy and expensive. Less expensive designs include the use of elastomers that are compressed during wheel impact loading. Elastomer suspension systems often do not incorporate rebound elastomers. These systems have hard stops that create an abrupt feel when energy is returned to the system following impact. Most elastomer type suspension systems offer little adjustability where the user can alter the characteristics of the suspension system for their body weight and ride preference. What is needed is a suspension system that is lightweight, low cost, low maintenance, is user adjustable, and provides rebound shock absorption. What is also needed is a wheelchair suspension system that can be optionally added to a wheelchair that uses many parts common with the non-suspension system and requires few additional suspension specific parts.

The use of anti-tip devices and travel wheels is well known in the industry. These devices are typically offered as optional accessories. Anti-tip devices are designed to prevent a wheelchair from tipping over backwards. They typically consist of extension tubes that extend rearward and downward in order to position small wheels behind the standard rear wheels, just above the ground. The anti-tip wheels contact the ground in the event that the wheelchair tips rearward, preventing the chair from tipping over. Travel wheels are devices used for entering tight confines. Often narrow doorways and airplane aisles prevent wheelchair access because the wheelchair with rear wheels is too wide. Travel wheels are small rear wheels situated inboard of the seat frame, and just above the ground contact point of the standard rear wheels. To create a narrower wheelchair width the standard rear wheels are removed and the wheelchair rolls on the travel wheels. What is needed is a wheelchair with center-of-gravity, toe-in/toe-out and rear wheel height adjustability that includes the ability to mount optional accessories such as travel wheels and anti-tip devices. Such devices should be compatible with a large range of adjustment while using few accessory sizes to cover this range. Such devices should also be compatible with a wheelchair suspension option.

### SUMMARY OF INVENTION

The present invention is directed towards a rear wheel mount and suspension that meets the foregoing needs. The wheel mount generally may be comprised of an axle plate and a camber tube clamp that may be height adjustable with respect to the axle plate. According to another embodiment of the invention, the camber tube clamp may be selectively mountable upright or inverted so as to increase an overall range of height adjustability. According to yet another embodiment of the invention, the camber tube clamp can be selectively mountable in front of or behind the axle plate so as to increase an overall range of center-of-gravity adjustability. According to still another embodiment of the invention, the camber tube clamp and the axle plate may have an interlocking feature that allows the camber tube clamp to slide vertically along the axle plate to facilitate height adjustment. A seat collar can be positioned at various locations along a wheelchair frame for center-of-gravity adjustment. The axle plate can be detached from and attached to the seat tube collar to allow the axle plate and camber tube clamp to be reverse mounted in order to increase the range of center of gravity adjustment.

A wheelchair suspension system according to the invention comprises a swing arm and one or more elastomers. The swing arm is adapted to support a rear wheel of a wheelchair and adapted to pivot about an axis substantially fixed to a wheelchair frame. The swing arm may be suspended between two elastomers.

According to another embodiment of the invention, the wheelchair suspension system may be comprised of a swing arm for supporting a rear wheel of a wheelchair. The swing arm may be adapted to pivot about an axis that is adapted to be substantially fixed relative to a wheelchair frame. An elastomer may be operatively connected to the swing arm so that displacement of the swing arm in either direction about the pivot causes the elastomer to compress.

Various objects and advantages of this invention will become apparent to those skilled in the art from the following detailed description of the preferred embodiment, when read in light of the accompanying drawings.

### BRIEF DESCRIPTION OF DRAWINGS

FIG. 1 is a side elevational view of a rear wheel mount according to one embodiment of the invention.

FIG. 2 is an exploded rear perspective view of the rear wheel mount shown in FIG. 1.

FIGS. 3A-3D are side elevational views of the rear wheel mount in FIGS. 1 and 2.

FIG. 4 is a side elevational view of a rear wheel suspension according to one embodiment of the invention.

FIG. 5 is a partially exploded rear perspective view of the rear wheel suspension shown in FIG. 4.

FIG. 6 is a side elevational view of an axle plate according to one embodiment of the invention.

FIG. 7 is a partially exploded rear perspective view of the axle plate shown in FIG. 6.

FIG. 8 is a side elevational view of an axle plate in combination with a rear wheel suspension.

FIG. 9 is a partially exploded rear perspective view of the axle plate and the rear wheel suspension shown in FIG. 8.

### DETAILED DESCRIPTION

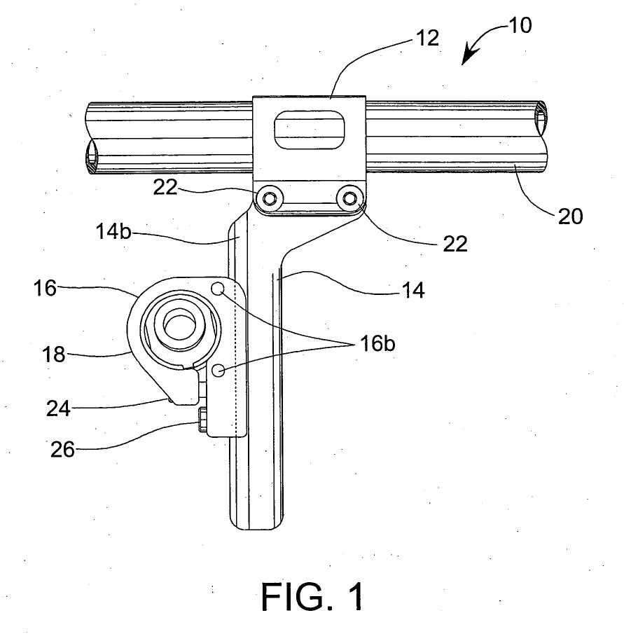

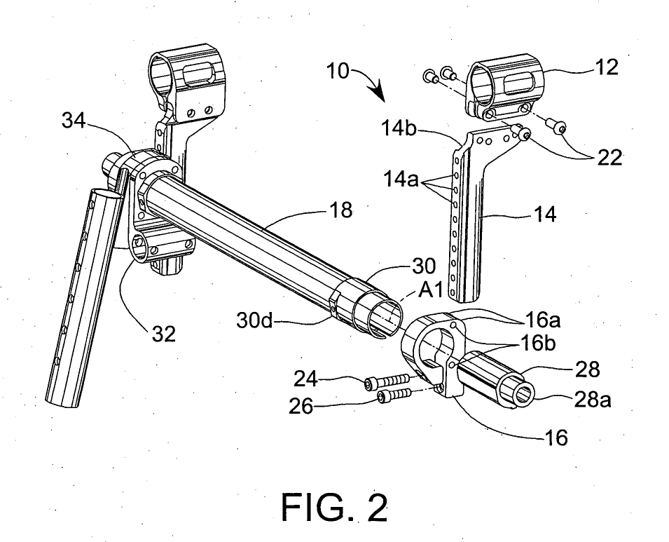

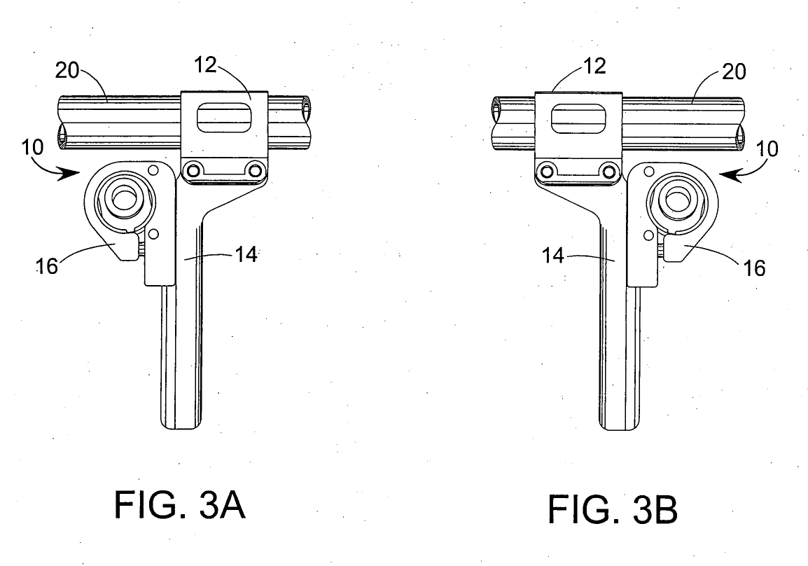

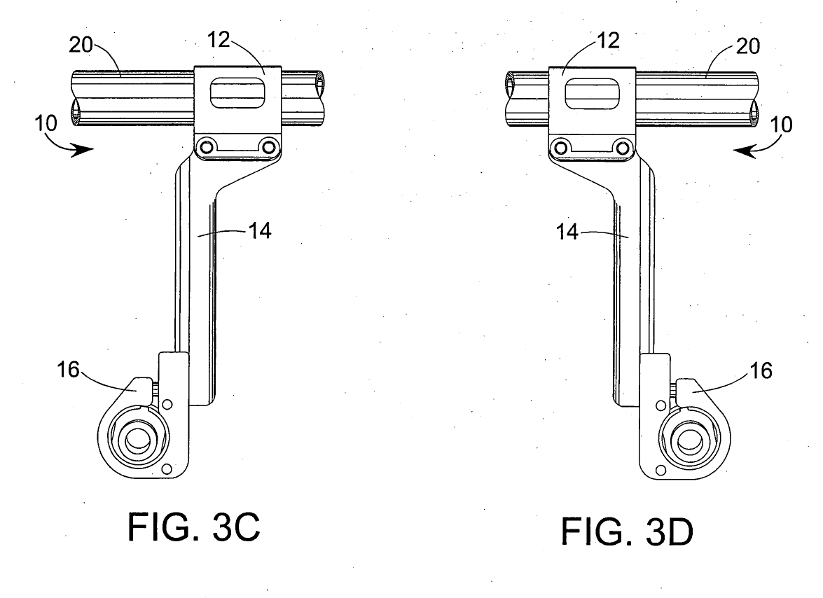

Referring now to the drawings, there is illustrated in FIGS. 1 and 2 a rear wheel mount assembly 10 for a wheelchair or other personal mobility vehicle. The rear wheel mount assembly 10 may provide lightweight means for attaching rear wheels to a wheelchair frame. The rear wheel mount assembly 10 may provide adjustability in rear wheel height, camber toe-in/toe-out, and center-of-gravity. The rear wheel mount assembly 10 may be generally comprised of a coupling, such as the seat tube collar 12 shown, an axle support or plate 14, which preferably has a free end that is adapted to be cantilevered from a side frame member of a wheelchair, and a camber tube clamp 16, or other suitable fastener. Two rear wheel mount assemblies 10, one left and one right, are adapted to be attached to a camber tube 18 (see FIG. 2), which is adapted to support two rear wheels (not shown). The seat tube collar 12 may include a clamp or other suitable coupling, that is adapted to be fitted around a seat tube 20 (or other frame member) that allows the camber tube 18 to be secured at various fore/aft positions. By loosening collar clamp screws 22 on both sides of the wheelchair, the rear wheel mount assembly 10 can slide along the seat tube 20 (or other frame member), preferably over a specific range of movement, for center-of-gravity adjustment. In addition, the axle plates 14 may be detached from the seat tube collar 12, and be reverse mounted, so that the left axle plate may be attached to the right seat tube collar 12, and the right axle plate may be attached to the left seat tube collar 12 (see FIGS. 3A-3D). This reverse mounting places the camber tube 18 in front of the axle plates 14, and has the effect of increasing the overall range of center-of-gravity adjustment without increasing the space required on the seat tube 20 where the seat tube collar 12 slides. This design, wherein the axle plate 14 can detach from the seat tube collar 12, is also beneficial because it allows the same rear wheel mount assembly 10 to be mounted on the left and right sides of the wheelchair without having parts that are left/right specific, thereby reducing the number of required parts, and parts cost.

As shown in FIG. 2, the axle plate 14 may have a series of evenly spaced holes 14a that allow positioning of the camber tube clamp 16 at various heights for rear wheel height adjustment. The camber tube clamp 16 may have ears 16a that slide along mating grooves 14b in the axle plate 14. This interlocking feature may facilitate rear seat height adjustment by allowing the camber tube clamp 16 to remain engaged with the axle plate 14 when height adjustment fasteners 24, 26 are removed. To adjust rear seat height, the user could simply remove the fasteners 24, 26 that secure the camber tube clamp 16 to the axle plate 14, slide the camber tube clamp 16 to a desired height, and reinstall and tighten the fasteners 24, 26. In addition, the camber tube clamps 16 may be inverted (i.e., oriented right side-up or upside-down) on the axle plates 14 (see FIGS. 3A-3D). By providing these two orientations, the range of adjustment of the rear seat height is extended without having to extend the overall height of the axle plate 14. A short axle plate is desirable because it creates a more compact wheelchair package size that is easier to load, for example, into a car. Likewise, fewer positioning holes 14a in the axle plate 14 may be desirable to cover a relatively large range in rear seat height adjustments, thereby reducing the cost, weight and size of the axle plate 14.

The camber tube 18 may have axle plugs 28 situated at opposing ends thereof. A central bore 28a in these axle plugs 28 may support a rear wheel axle (not shown) and may be tilted with respect to the axis A1 of the camber tube 18. This tilt angle could provide the rear wheels with camber. Toe-in/toe-out may be eliminated by rotating the camber tube 18 within the camber tube clamps 16 until the camber axis is substantially horizontal. The camber tube 18 may have a collar 30 situated inboard of the camber tube clamp 16. This collar 30 may permit the camber tube 18 to be kept substantially centered side-to-side or laterally on the wheelchair. The collar 30 may have a flat surface 30a that could be used for toe-in/toe-out adjustment. To make toe-in/toe-out adjustment, the user could simply loosen the fasteners 24 on the left and right camber tube clamps 16, rotate the camber tube 18 until the collar flat surface 12a is oriented vertically, and then retighten the fasteners 24.

The camber tube clamp 16 may be a convenient location for mounting optional accessories, such as anti-tip receivers 32 and travel wheel receivers 34. The camber tube clamp 16 may have two tapped cross-holes 16b that are used for mounting an anti-tip receiver 32 and/or a travel wheel receiver 34. The location of the anti-tip wheels and travel wheels (not shown) with respect to the standard rear wheels may be important to maintain rearward stability and prevent rearward tip over. Mounting these accessories to the camber tube clamp 16 may ensure that the accessory wheels will be correctly located with minimal adjustment, regardless of the rear seat height and center-of-gravity adjustment in the wheelchair. This mounting may have the advantage of requiring fewer sizes of anti-tip and travel wheel extension tubes (not shown) because tube receivers 32, 34 may be able to remain stationary with respect to the rear wheel as adjustment to the center-of-gravity or rear wheel height is made. This could reduce inventory of parts, and reduce the risk that a user will need to order a different length extension tube when adjusting the rear wheel location.

In the preferred embodiment, the ears 16a of the camber tube clamp 16 may slide along mating grooves 14b in the axle plate 14. This interlocking feature may facilitate rear seat height adjustment by allowing the camber tube clamp 16 to remain attached to the axle plate 14 when the height adjustment screws 24, 26 are removed. It is noted that other means of attaching the camber tube clamp 16 to the axle plate 14 are possible, including, for example, a T-slot or tongue in groove slot, or any interlocking feature that may allow the axle plate 14 and camber tube clamp 16 to maintain an interface that may provide height adjustment of the camber tube clamp 16. Such other means of attachment are within the scope of this patent.

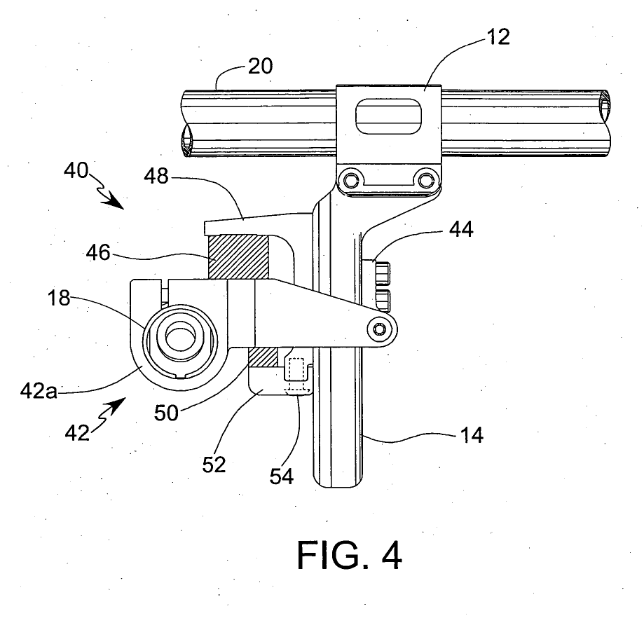

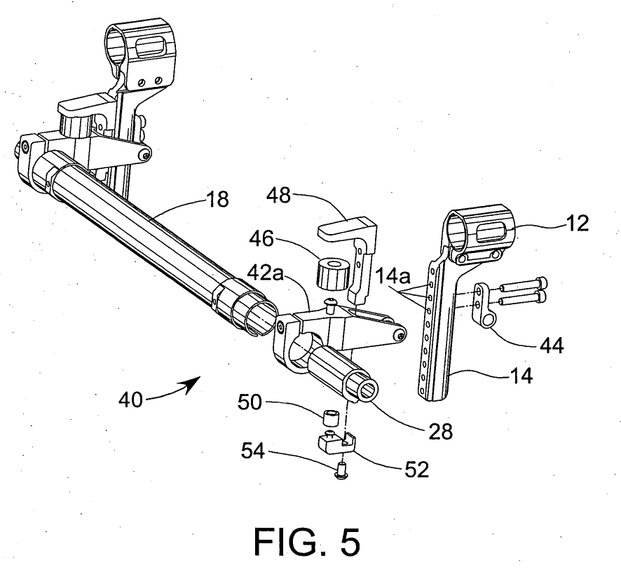

The axle plate 14 may be designed to accept both rigidly mounted rear wheels, as described above with respect to FIGS. 1-3D, and rear wheels with a suspension system 40, as illustrated in FIGS. 4 and 5. The rear suspension system 40 preferably comprises left and right swing-arms 42 that clamp to the camber tube 18 on both sides of the wheelchair. Toe-in/toe-out may be substantially eliminated by rotating the camber tube 18 within the swing-arm clamps 42a until the camber axis is substantially horizontal. Each swing-arm 42 may pivot about a pivot carriage 44 attached to the front side of the axle plate 14. The swing-arm 42 may be suspended between a shock elastomer 46 mounted to an upper elastomer carriage 48, and a smaller rebound elastomer 50 mounted to the lower elastomer carriage 52. The series of evenly spaced holes 14a (see FIG. 5) on the axle plate 14 may allow the pivot carriage 44 and upper elastomer carriage 48 to be positioned at various heights on the axle plate 14 for rear seat height adjustment. The lower elastomer carriage 52 is may be tightened against the upper elastomer carriage using, for example, a pretension screw 54. Tightening the pretension screw 54 may place both the shock and rebound elastomers 46 and 50 under compression. As the rear wheel is subjected to an upward shock load, for example, when going over a bump, the swing arm 42 may be displaced upward, compressing the shock elastomer 46. The shock elastomer 46 may absorb energy from the impact, and return some of that energy causing the swing arm 42 to rebound. The rebound elastomer 50 may absorb rebound energy, helping the suspension system 40 come gently to rest. The elastomers 46, 50 may have both spring and damping characteristics that may be tailored to create optimal ride performance. A heavier user may require stiffer elastomers than a lighter user. This invention allows the user to easily interchange elastomers of varying stiffness for their particular body weight and riding preference.

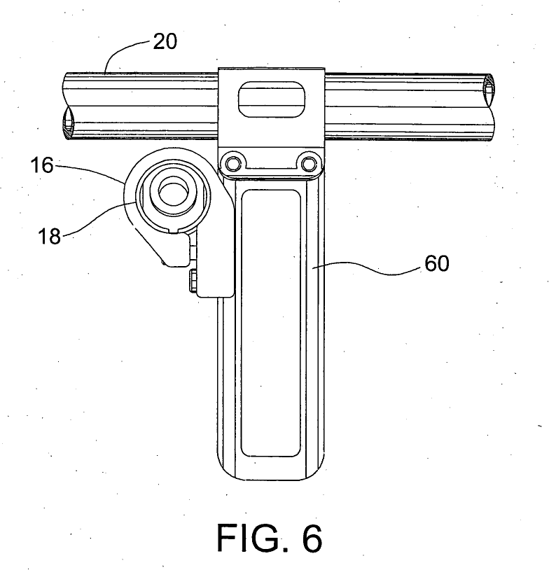

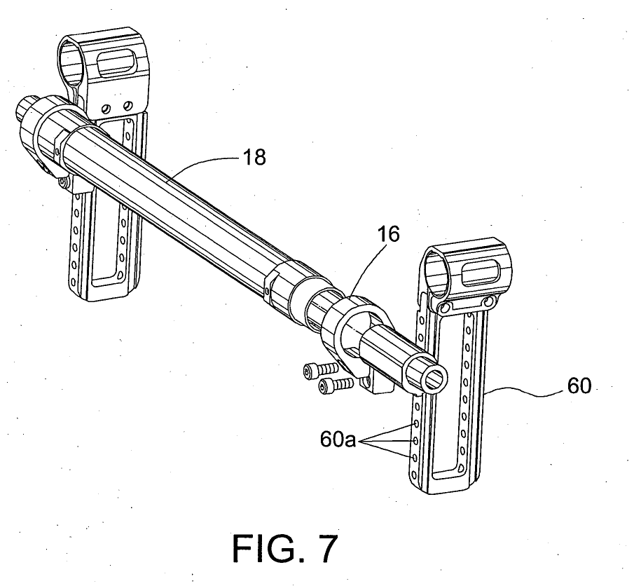

Another embodiment of the wheelchair axle plate 60 is shown in FIGS. 6 and 7. This axle plate 60 may be similar in form and function to the embodiment described above, except that this axle plate 60 may have an open rectangular shape. A series of tapped holes 60a may be available on either side of the axle plate 60 for mounting the camber tube clamp 16. The camber tube 18 can be mounted in front, or behind the axle plate 60 in order to increase the range of center of gravity adjustment. The camber tube clamp 16 can be mounted upright, as shown, or inverted (not shown) in order to increase the range of rear seat height adjustment without increasing the height of the axle plate 60.

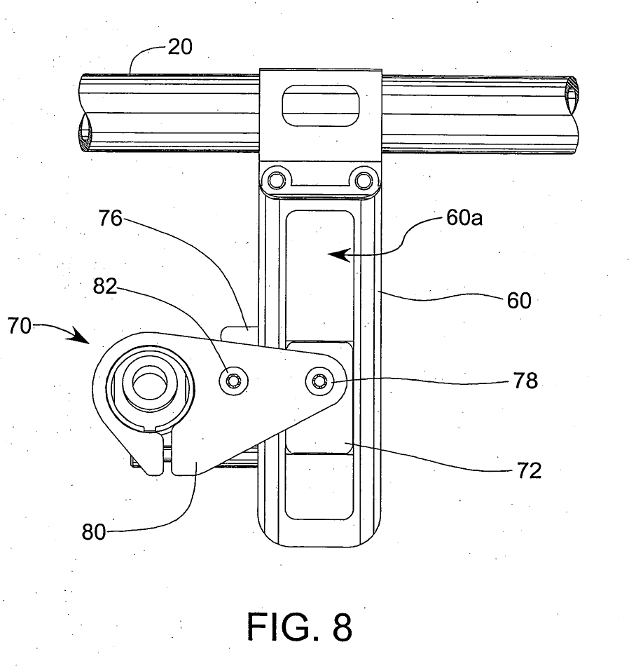

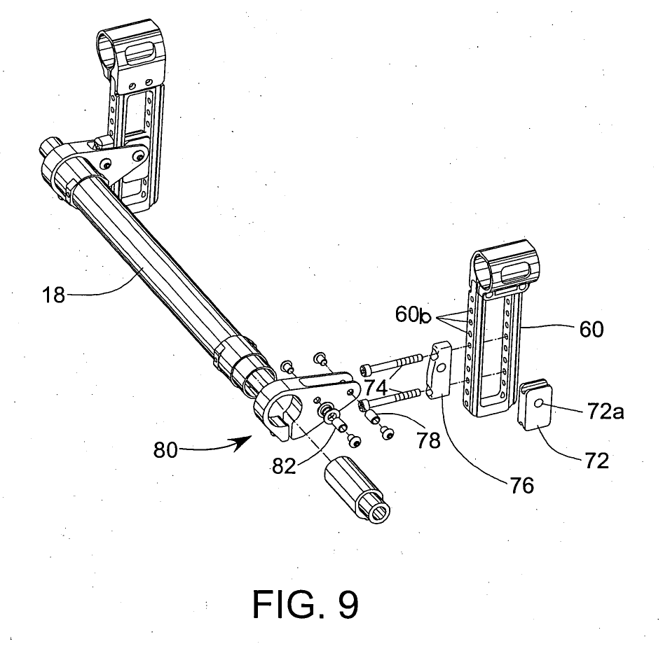

A suspension system 70 can be mounted on this axle plate 60, as shown in FIGS. 8 and 9. This suspension system 70 may be similar in function to the suspension system 40 of the preferred embodiment described above, except that the shock and rebound elastomers 46 and 50 may be replaced by a single elastomer 72 that provides shock absorption upward and rebound absorption downward. The elastomer 72 may be generally rectangular in shape and reside within an open cavity 60a of the axle plate 60. Cross bolts 74 may threadably engage the tapped holes 60b in the side of the axle plate 60 to secure a swing arm pivot 76 and capture top and bottom surfaces of the elastomer 72. This may allow the elastomer 72 to travel with the swing arm 80 as the elastomer 72 and swing arm are repositioned vertically for rear seat height adjustment. An elastomer bushing 78 may be secured to a swing arm 80 and pass through a cross-hole 72a in the elastomer 72. As the swing arm 80 is loaded during impact, the swing arm 80 may pivot about a swing arm pivot bushing 82 and the elastomer bushing 78 may push downward on the elastomer 72, compressing the elastomer material that is below the elastomer bushing 78. During rebound, as the swing arm 80 rotates in the opposite direction about the swing arm pivot bushing 82, the elastomer bushing 78 may compress the elastomer material above the elastomer bushing 78. This suspension system 70 may have the advantage of using a single elastomer 72, rather than two elastomers 46, 50, as described above. However, the suspension system 70 may not provide the ability to preload the elastomer 72.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A wheel mount assembly comprising:
an axle support having a free end that is adapted to be cantilevered from a side frame member; and
a camber tube clamp that is height adjustable with respect to the axle support.

2. The wheel mount assembly of claim 1, wherein the camber tube clamp is selectively mountable upright or inverted so as to increase an overall range of height adjustability.

3. The wheel mount assembly of claim 1, wherein the camber tube clamp is selectively mountable in front of or behind the axle support so as to increase an overall range of center-of-gravity adjustability.

4. The wheel mount assembly of claim 1, wherein the camber tube clamp and axle plate have an interlocking feature that allows the camber tube clamp to slide vertically along the axle support to facilitate height adjustment.

5. A wheel mount assembly comprising:
an axle support;
a camber tube clamp attachable to the axle support; and
a seat tube collar attachable to a wheelchair side frame member, the axle support being attachable to the seat tube collar and having a free end that is adapted to be cantilevered from the wheelchair side frame member.

6. The wheel mount assembly of claim 5, wherein the seat tube collar is selectively positionable at one of a variety of locations along a wheelchair side frame member for center-of-gravity adjustment.

7. The wheel mount assembly of claim 5, wherein the axle support is selectively detachable from and attachable to the seat tube collar to allow the axle support and camber tube clamp to be reverse mounted in order to increase a range of center of gravity adjustment.

8. The wheel mount assembly of claim 5, wherein the axle support is selectively attachable to the seat tube collar in at least two different orientations in order to allow the seat mount assembly to selectively mount on a left side and a right side of a wheelchair.

9. The wheel mount assembly of claim 5, wherein the axle support is detachable from the seat tube collar in order to allow interchangeability with a different axle support.

10. A wheelchair suspension system comprising:
a swing arm for supporting a wheel of a wheelchair, the swing arm being adapted to pivot about an axis that is substantially fixed relative to a wheelchair frame; and
an elastomer operatively connected to the swing arm so that displacement of the swing arm about the pivot causes the elastomer to compress.

11. The wheelchair suspension system of claim 10, further comprising a support adapted to be in a fixed relation to a wheelchair frame, a swing arm being supported for pivotal movement relative to the support and having free end cantilevered relative to the pivot point, the elastomer being supported in a fixed relation to the support and engageable with the swing arm so that pivotal movement of the swing arm causes the elastomer to compress.

12. The wheelchair suspension system of claim 11, wherein the elastomer is one of two elastomers supported in a fixed relation to the support and engageable with opposing surfaces of a free end of the swing arm so that pivotal movement of the swing arm in either direction about a pivot point causes a corresponding one of the elastomers to compress.

13. The wheelchair suspension system of claim 12, wherein the elastomers provide shock absorption to the swing arm in an upward direction and a downward direction.

14. The wheelchair suspension system of claim 12, wherein the elastomers are adapted to be pre-compressed.

15. The wheelchair suspension system of claim 12, wherein the elastomers are adapted to be pre-compressed by an adjustable amount of pre-compression.

16. The wheelchair suspension system of claim 12, further comprising a threaded fastener and a carriage for clamping the elastomers under preload compression.

17. The wheelchair suspension system of claim 10, a rear wheel of a wheelchair supported by the swing arm.

18. The wheelchair suspension system of claim 10, wherein the elastomer is operatively connected to the swing arm so that displacement of the swing arm in either direction about the pivot causes the elastomer to compress.
